(19) United States
(12) Patent Application Publication
(10) Pub. No.: US 2007/0260473 A1
(43) Pub. Date: Nov. 8, 2007

(54) Business method for use with a mixed-use building having a commercial showroom and a multi-unit structure directly accessible therefrom

(76) Inventor: John Cornacchia, Toronto (CA)

Correspondence Address: YOUNG & BASILE, P.C., 3001 WEST BIG BEAVER ROAD, SUITE 624, TROY, MI, 48084, US

(21) Appl. No.: 11/586,466

(22) Filed: Oct. 25, 2006

Related U.S. Application Data
(63) Continuation-in-part of application No. PCT/CA06/00659, filed on Apr. 25, 2006.

(51) Int. Cl. G06Q 10/00

(52) U.S. Cl. 705/1; 52/33

(57) ABSTRACT

Disclosed is a business method for use with a building comprising a commercial showroom and a multi-occupancy structure directly accessible from the showroom. The method comprises the steps of providing, for compensation, tenancy rights to said showroom to a business associated with a brand; obtaining rights to use the brand in association with said structure; and providing, for compensation, occupancy rights to the units in said structure. Also disclosed is an improved multi-story building of the type having an adjacent road and residential dwelling units disposed on more than one of said stories. The improvement comprises a plurality of vehicle-receiving pads disposed in vertically-spaced relation to one another, each pad being associated with a respective one of the units and contiguous therewith. Apparatus for use with the improved building is also disclosed and comprises means for moving said vehicle between the staging area and the stand of each pad.

### RELATED APPLICATIONS

This continuation-in-part application claims priority to PCT Application No. PCT/CA2006/000659, dated Apr. 25, 2006, the content of which is incorporated herein by reference.

### FIELD OF THE INVENTION

This invention relates to real estate development.

### BACKGROUND OF THE INVENTION

One type of common real estate development is the stand-alone commercial development. This type of development often includes a building or buildings having indoor showroom space. Often, such showroom space is devoted to the sale of goods or services associated with a brand. This type of development also often includes a large space for vehicle parking, to accommodate vehicles of customers and employees. The relatively large footprint associated with this type of development renders same relatively expensive.

Another common type of real estate development is the multi-unit residential complex. This type of development usually includes a building or buildings defining a plurality of residential dwelling units. Vehicle parking space is also provided, which can be surface parking or underground parking. This type of development is so widespread in many places that new developments of this type can be viewed negatively in the marketplace unless measures are taken to render such developments distinctive.

### SUMMARY OF THE INVENTION

A building forms one aspect of the invention. The building comprises a commercial showroom and a multiple occupancy structure directly accessible from the retail showroom.

An improved multi-story building forms another aspect of the invention. The improved building is of the type having an adjacent road and residential dwelling units disposed on more than one of said stories. The improvement comprises a plurality of vehicle-receiving pads disposed in vertically-spaced relation to one another, each pad being associated with a respective one or the dwelling units and contiguous therewith. Preferably, each of the vehicle-receiving pads has a stand for supporting a vehicle in elevated relation to said each pad, and the building has a staging area and also has a track area along which vehicles can be driven and which extends between the staging area and said adjacent road.

Apparatus for use with the preferred improved multi-story building and with a vehicle forms yet another aspect of the invention. The apparatus comprises vehicle transport means for moving said vehicle between the staging area of said building and the stand of each vehicle-receiving pad of said building.

A business method forms yet a further aspect of the invention. The business method is for use with a building comprising a commercial showroom and a multiple occupancy structure directly accessible from the commercial showroom. The method comprises the steps of: providing, for compensation, occupancy rights to said commercial showroom to a business associated with a brand; obtaining rights to use the brand in association with said multi-unit structure; and providing, for compensation, occupancy rights to the units in said multiple-occupancy structure.

Other aspects and features of the present invention will be understood by those of ordinary skill in the art from a review of the following detailed description read in conjunction with the accompanying figures, a brief description of the latter following hereinafter.

### BRIEF DESCRIPTION OF THE DRAWINGS

FIG. 1 is a top view of a building constructed according to a first preferred embodiment of the invention.

FIG. 2 is a view along section 2-2 of FIG. 1;

FIG. 3 is a view along section 3-3 of FIG. 1;

FIG. 4 is a plan view of an underground floor of the building of FIG. 1;

FIG. 5 is a plan view of a ground floor of the building of FIG. 1;

FIG. 6 is a plan view of a second floor of the building of FIG. 1;

FIG. 7 is a plan view of a third floor of the building of FIG. 1;

FIG. 8 is a partial perspective view of the building of FIG. 1, showing: a vehicle disposed at a staging area of said building; vehicle transport means of said building; and a plurality of vehicle receiving pads of said building;

FIG. 9 is a view similar to FIG. 8, showing the vehicle at a position horizontally adjacent a respective one of the vehicle receiving pads;

FIG. 10 is a view similar to FIG. 9, showing the vehicle disposed above the stand of the respective vehicle receiving pad;

FIG. 11 is a view similar to FIG. 10, with a cradle partially retracted;

FIG. 12 is a top view of a building constructed according to a second preferred embodiment of the invention;

FIG. 13 is a view along section 13-13 of FIG. 12;

FIG. 14 is a plan view of an underground floor of the building of FIG. 12;

FIG. 15 is a plan view of a ground floor of the building of FIG. 12;

FIG. 16 is a plan view of a second floor of the building of FIG. 12; and

FIG. 17 is a plan view of a third floor of the building of FIG. 12.

### DETAILED DESCRIPTION OF THE ILLUSTRATIVE EMBODIMENT

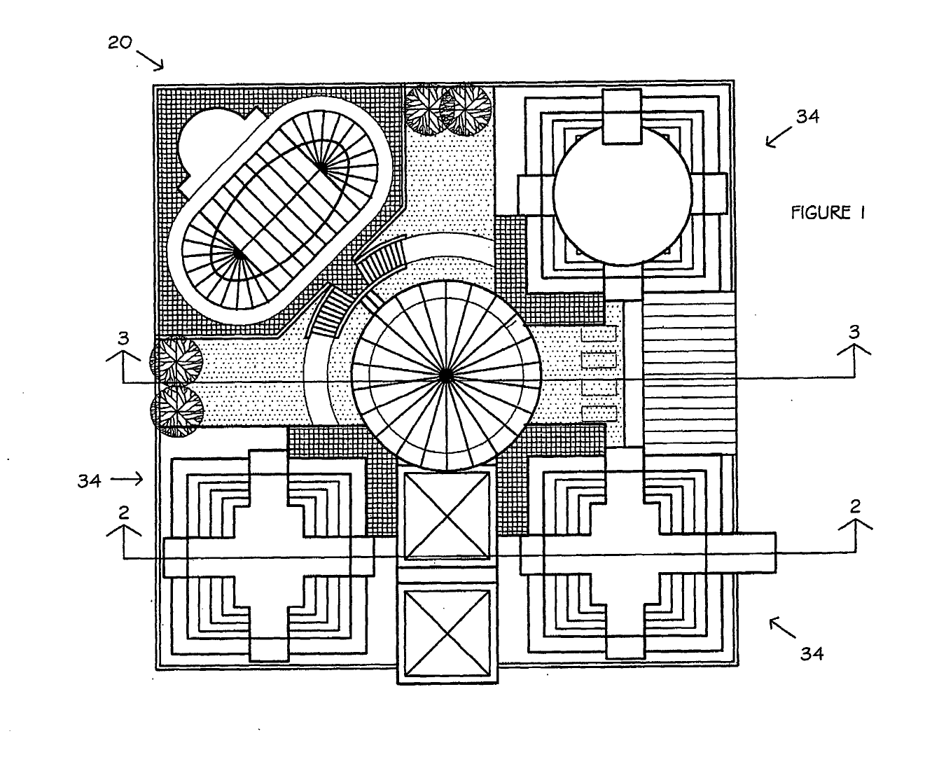

A business method according to a preferred embodiment of the invention will be hereinafter described in detail. However, firstly, a preferred embodiment of a building 20, with which the method is used, is described, with general reference to FIGS. 1-7.

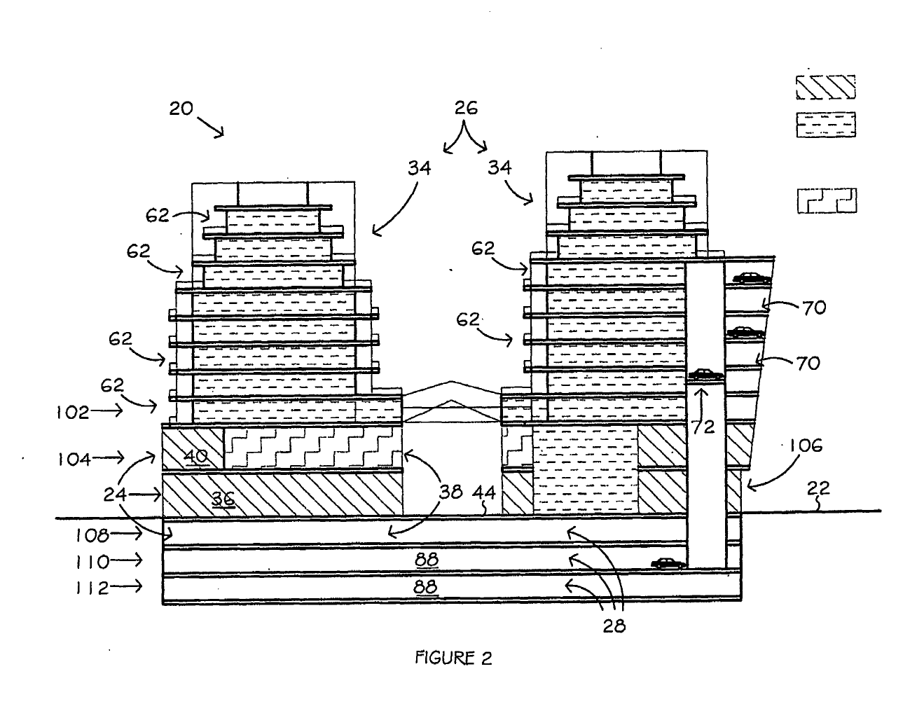

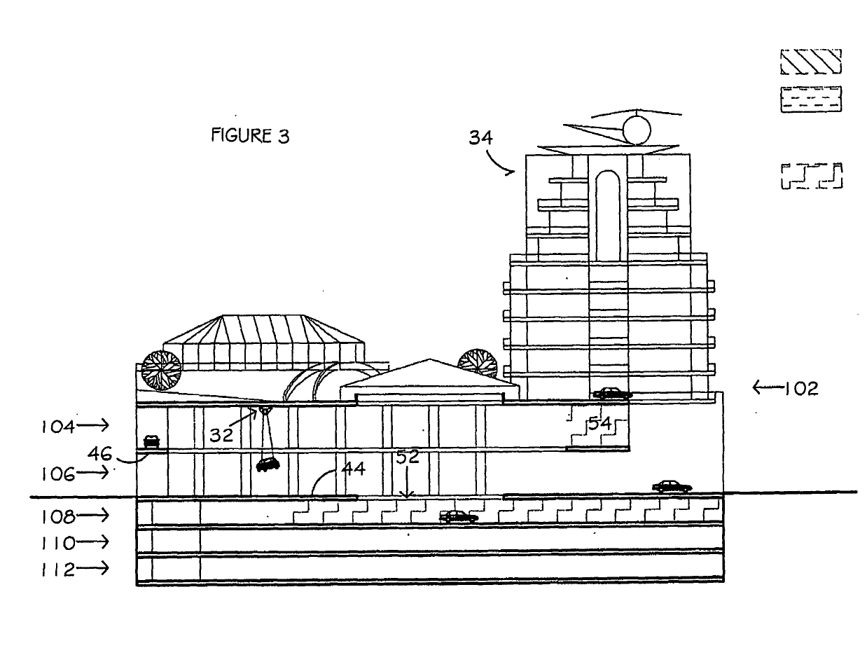

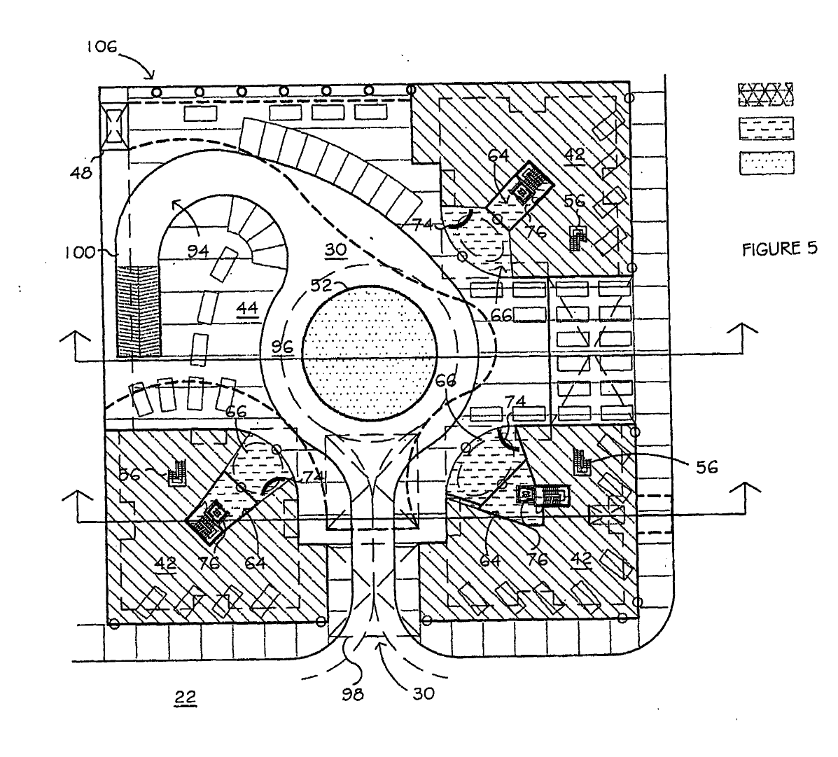

With reference to FIG. 2 the building 20 will be seen to have an adjacent road 22 and to comprise an automotive dealership space 24, a multi-unit residential structure 26 and automotive parking space 28. The building 20 further comprises a track 30, best seen in FIG. 5, and a crane 32, best seen in FIG. 3. The foregoing is provided in a multiple tower arrangement. As indicated in FIG. 1, three towers 34 are provided in the building 20 of the first preferred embodiment.

Returning generally to FIG. 2, the automotive dealership space 24 includes showroom space 36, service space 38 and office space 40.

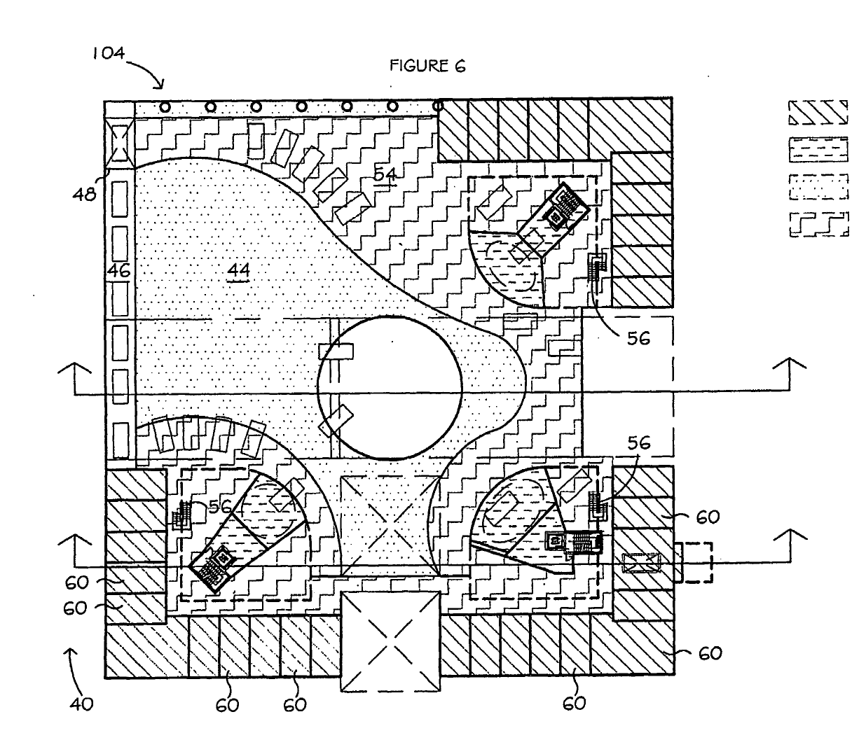

As best seen in FIG. 5, the showroom space 36 includes three commercial automotive showrooms 42, each associated with an automotive brand which the dealer represents and disposed on a ground floor 106 of the building 20. Each showroom 42 is adapted to house interiorly one or more motor vehicles of the brand associated therewith. The showroom space 36 also includes a showroom floor 44, exterior to the showrooms 42 and on the ground floor 106 of the three-tower structure 20, for displaying motor vehicles. The showroom space 36 also includes a vehicle display 46, best seen in FIGS. 3,6, which takes the form of at least one balcony 46 overlooking the showroom floor 44 and adapted to receive a number of vehicles arranged in front-to-back relation to one another, as indicated in phantom outline in FIG. 6. A car elevator 48 provides for transport of vehicles between the showroom floor 44 and the at least one balcony 46.

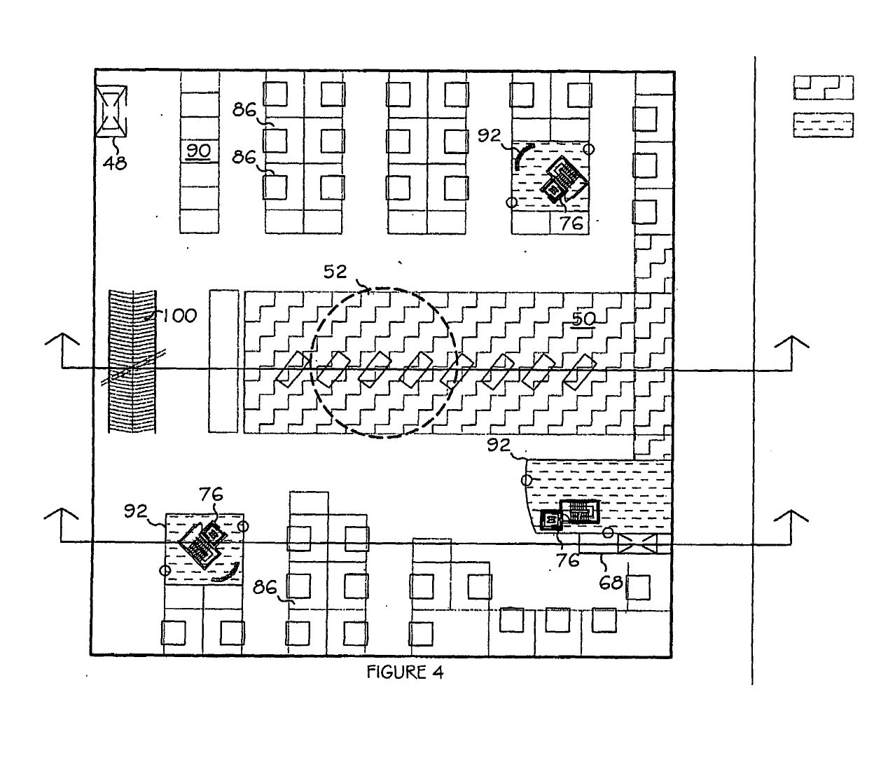

The service space 38 includes a service area 50 for servicing vehicles shown in FIG. 4, which service area 50 is disposed on an underground floor 108 of the building, upon which the ground floor 106 is disposed in stacked relation, as indicated in FIG. 2. The service area 50 is visible to persons standing on the ground floor 106 by means of a viewing port 52 defined through the showroom floor 44, as illustrated on FIG. 5. As indicated in FIG. 3, the service space 38 also includes a portion 54 on a second floor or concourse level 104 which is stacked upon the ground floor 104. With reference to FIG. 6, this portion 54 of the service space 38 overlies each of the showrooms 42 and overlooks the showroom floor 44. Staircases 56 provided in each tower 34 provide for human egress between the service area 54 on the concourse level 104 and each showroom 42. The service space 54 provided on the concourse level 104 defines a lounge area wherein, inter alia, persons having a vehicle serviced may wait.

The office space 40 takes the form of a plurality of offices 60 provided in each tower, contiguous with the service space 54.

The multi-unit residential structure 26 is spread amongst the three towers 34. As indicated in FIGS. 2,4,5, the structure 26 has a plurality of residential dwelling units 62, private lobby space 64, public lobby space 66, a staging area 68, a plurality of vehicle-receiving pads 70 and vehicle transport means 72.

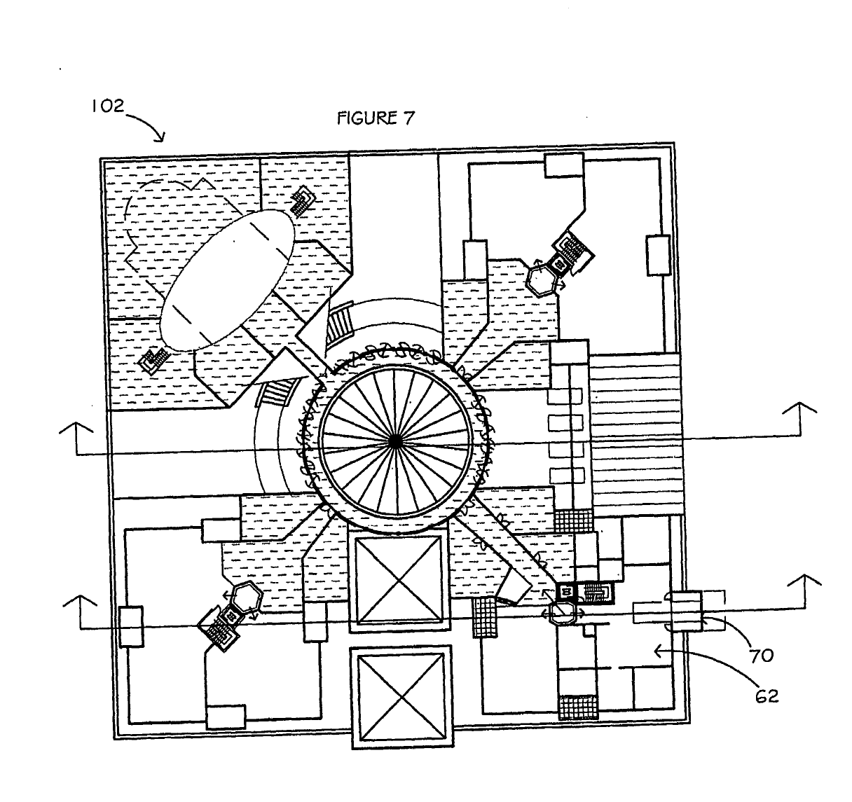

The residential dwelling units 62 in each tower 34 are disposed on more than one of said stories. The floor plan of one residential unit 62 on the third floor 102 of the building 20 is shown in FIG. 7, but it will be readily understood to persons of ordinary skill in the art that the floor plans of the various units can and will vary.

As best indicated in FIGS. 2,5, public lobby space 66 is provided in each tower 34, on the ground floor 106, contiguous with the showroom space 36. Nuances of the brand, including direct components, are incorporated in the public lobby spaces 66. Features that may be present include brand-embossed furniture; fixtures mimicking the controls of the brand's vehicle; brand-related memorabilia, photographs and artwork. A concierge counter 74 is provided in each public lobby space 66.

Private lobby space 64 is also provided in each tower 34, and is selectively accessible from the public lobby space 66 of said each tower 34. The concierge restricts such access, and in the absence of the concierge, a cardlock or the like is provided. Thus, the private lobby space 64 provides for selective direct access to the multi-unit structure 26 from the showroom space 36. Accessible from the private lobby space 64 is an elevator 76 which services the dwelling units 62 in the tower 34.

The plurality of vehicle-receiving pads 70 are disposed in vertically-spaced relation to one another, as shown in FIG. 2, each pad 70 being associated with a respective one or the dwelling units 62 and contiguous therewith, as indicated representatively in FIG. 7, and having a stand 78 for supporting a vehicle in elevated relation to said each pad, as indicated in FIG. 11.

With reference to FIG. 4, the staging area 68 is an area within the building 20 on the underground floor 108 for receiving a vehicle. The vehicle transport means 72 is for moving vehicles between the staging area 68 of said building 20 and the stand 78 of each vehicle-receiving pad 70 of said building 20. In the preferred structure shown, the vehicle transport means 72 includes a lift 80 and a vehicle cradle 82, shown in FIG. 11. The vehicle cradle 82 is adapted to support a vehicle by its undercarriage and is mounted to the lift 80 for horizontal movement from a retracted position nested within the lift 80 and a horizontally displaced extended position.

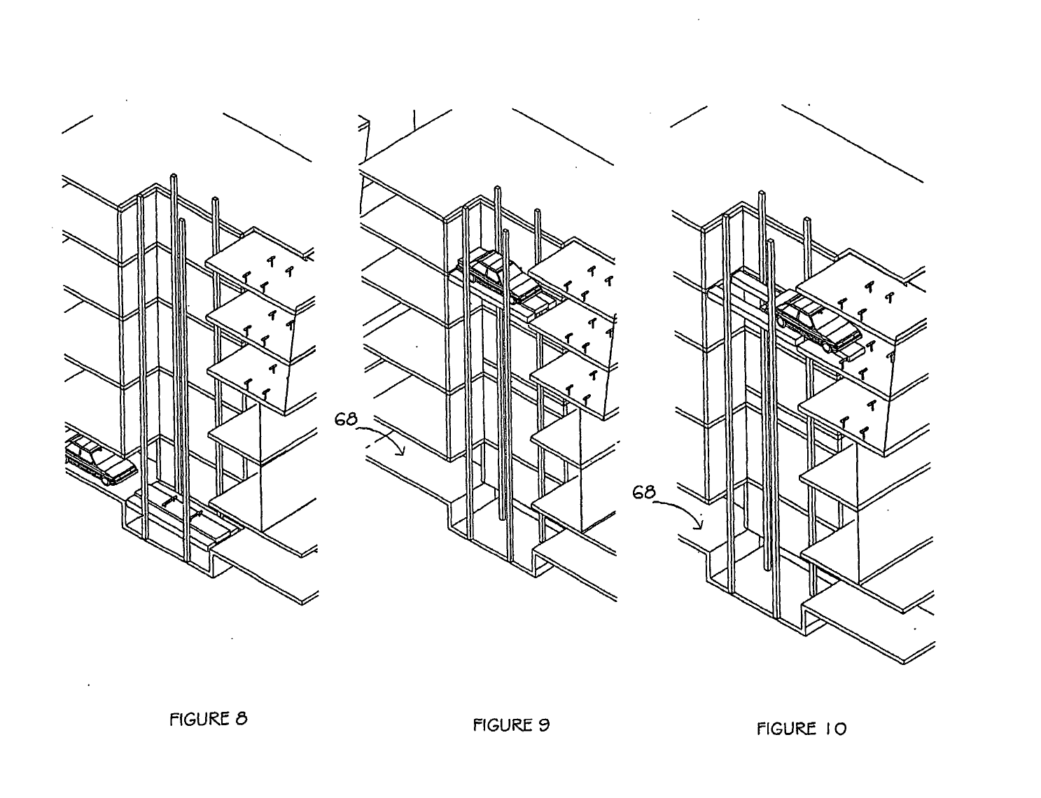

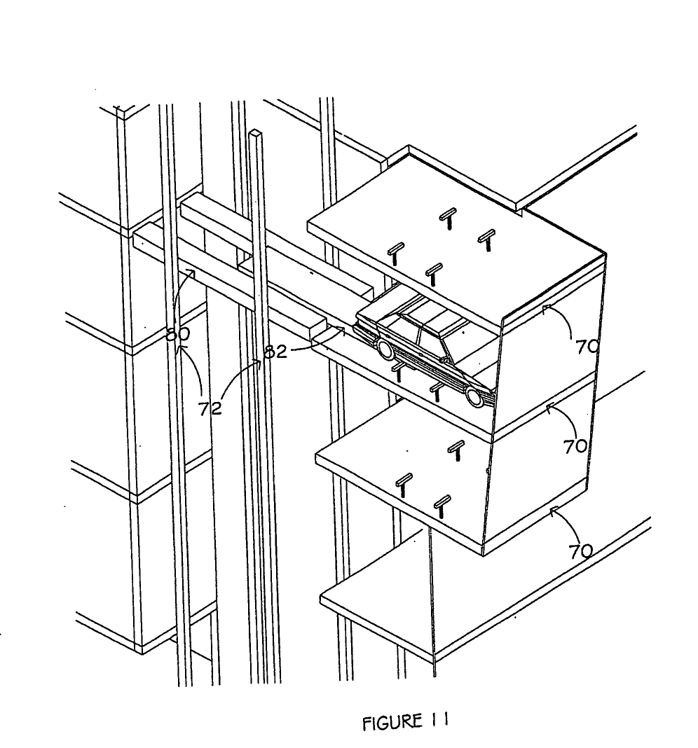

Transport of a vehicle to one of the vehicle-receiving pads 70 commences with the vehicle disposed at the staging area 68, the cradle 82 disposed at its retracted position and the lift 80 disposed at a position horizontally displaced from the vehicle, as shown in FIG. 8. In an initial operation, the cradle 82 is manipulated to its extended position, underneath the vehicle. Thereafter, the lift 80 is raised slightly, to elevate the vehicle off its wheels, and the cradle 82 is manipulated to its retracted position. In this configuration, the lift 80, cradle 82 and vehicle are elevated to a position horizontally displaced from the respective vehicle-receiving pad 70, as shown in FIG. 9. Thereafter, the cradle 82 is manipulated to its extended position, so as to position the vehicle above the stand 78 of the respective pad 70, as shown in FIG. 10, and the lift 80 is lowered, to set the vehicle on the stand 78 and free the cradle 82 from the vehicle. Thereafter, the cradle 82 can be returned to its retracted position, for a subsequent transport operation. FIG. 11 shows the cradle partially retracted from its position in FIG. 10. It will be readily understood by persons of ordinary skill in the art that a similar process, followed in reverse order, will result in transport of the vehicle back to the staging area 68.

The vehicle transport means 72 permits the owner of the vehicle to have same in his or her living space 62, for care and display. The stand 76 arrangement ensures that the vehicle, while in said living space, is not amenable to rolling movement, thereby to avoid the potential for catastrophic accident.

The automotive parking space 28 comprises a guest parking lot 90 and a plurality of individual glass carports 86 defined on the first underground floor 108, as shown in FIG. 4, and a parking lot 88 disposed on one or more basement levels 110,112 disposed in stacked relation beneath the first underground floor 108 and shown in FIG. 2. The elevators 76 servicing each tower 34 each extend to the first underground floor 108 and basement floors 110,112, and are suitably separated therefrom by lobbies 92 provided therefor, as shown in FIG. 4.

The track 30 provides a track area 94 along which a vehicle can be driven between the staging area 68 and said adjacent road 22. As shown in FIG. 5, in the building, the track area 94 extends from the adjacent road 22 to a turnaround 96 which circles the viewing port 52. A barrier or panel door 98 is provided at the roadway 22 to limit ingress and egress of vehicles during hours in which the dealership is not open; outside regular working hours, access to the track 30 is controlled by the concierges, who control the barrier 98 remotely. The track 30 further extends from the turnaround 96 to a ramp 100 which leads to the first underground floor 108. As shown representatively in FIG. 4, further ramps 100 are provided, to permit vehicle travel between the first underground floor 108 and the basement levels 110,112. The car elevator 48 also extends to the underground floor 108 and basement levels 110,112, to provide an additional mechanism for vehicle transport.

The crane 32 spans the showroom floor 44 and is adapted to permit a vehicle to be suspended over the showroom floor 44, for visual impact, as shown in FIG. 3. The crane 32 also permits vehicles or other large, heavy objects to be transported between the service area 50 and the showroom floor 44 or vehicle display 46.

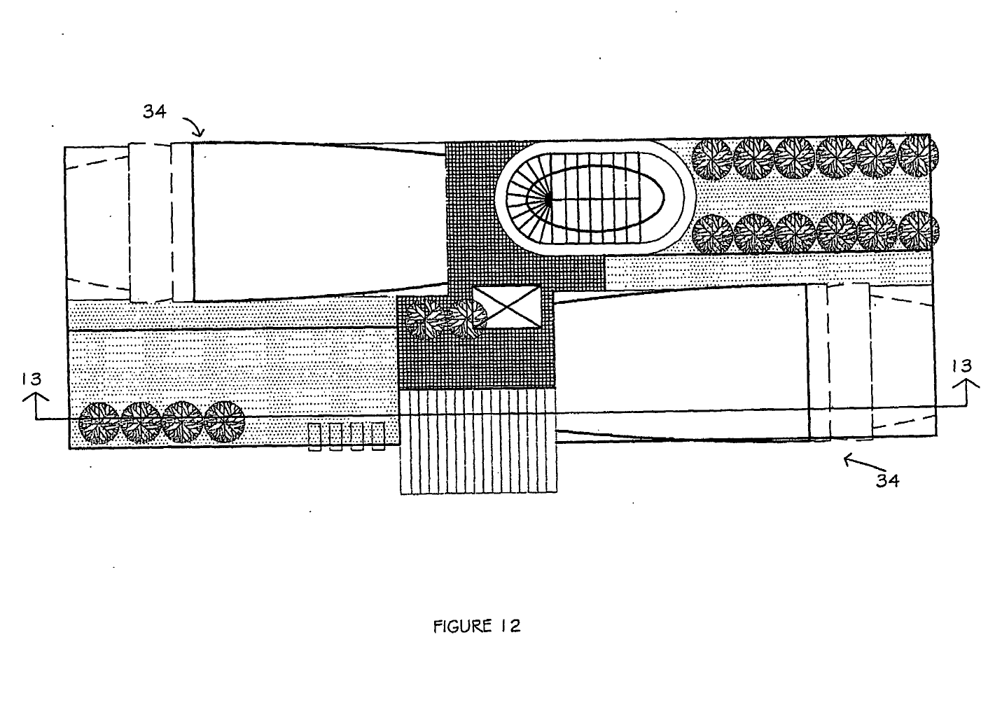

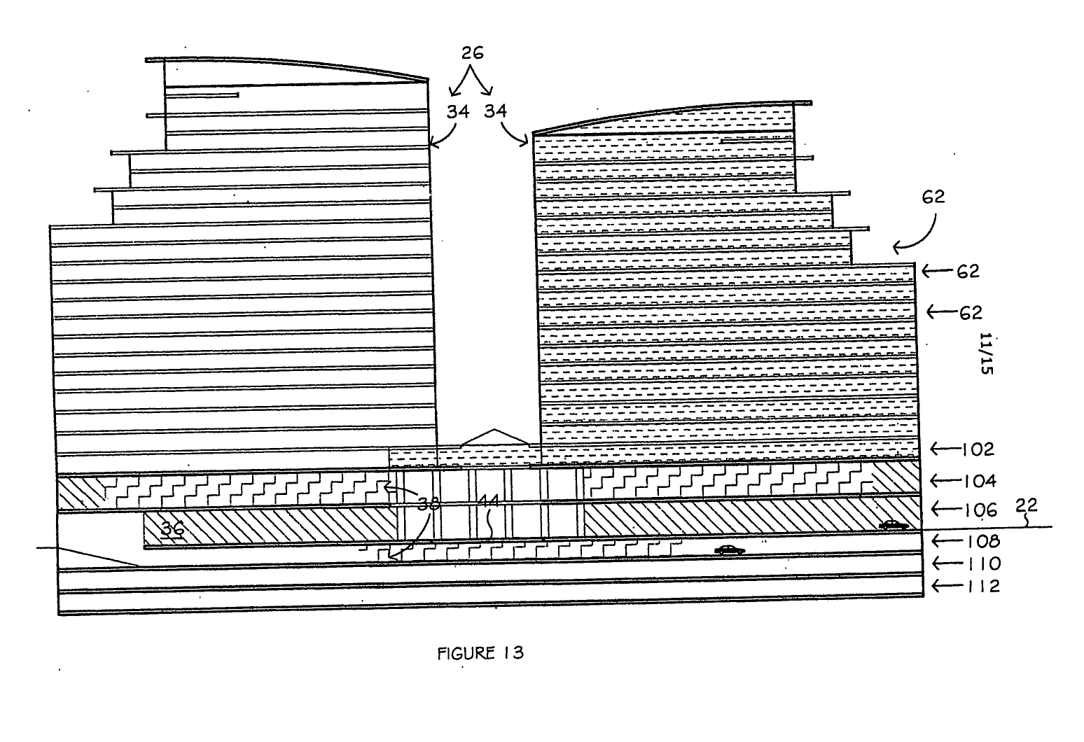

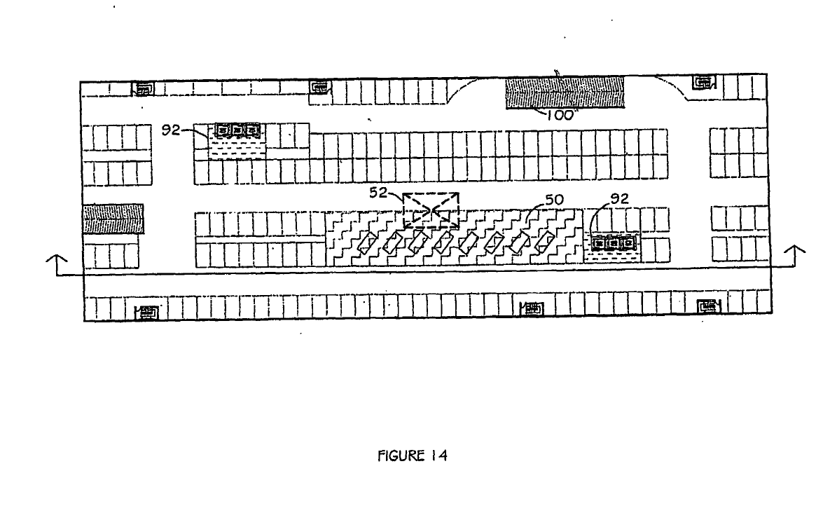

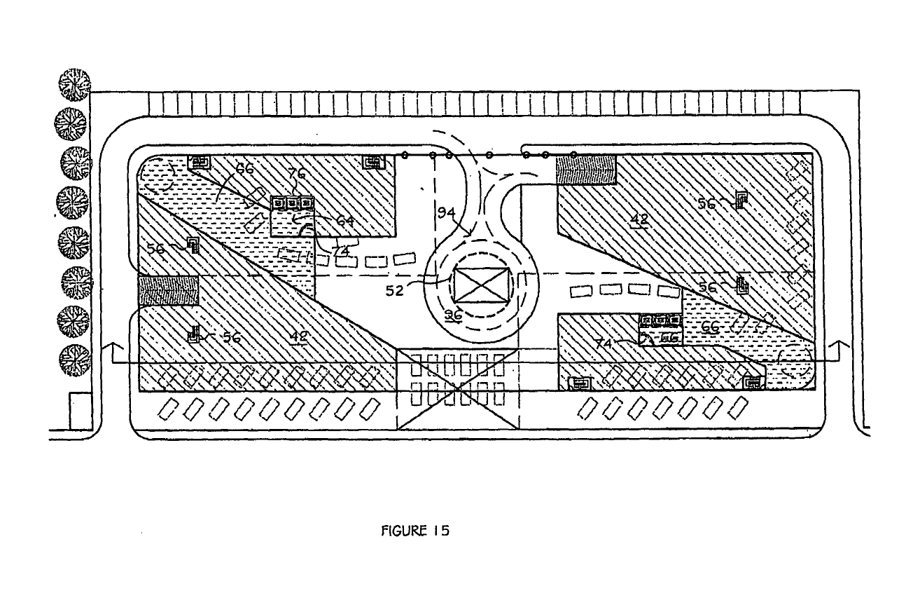

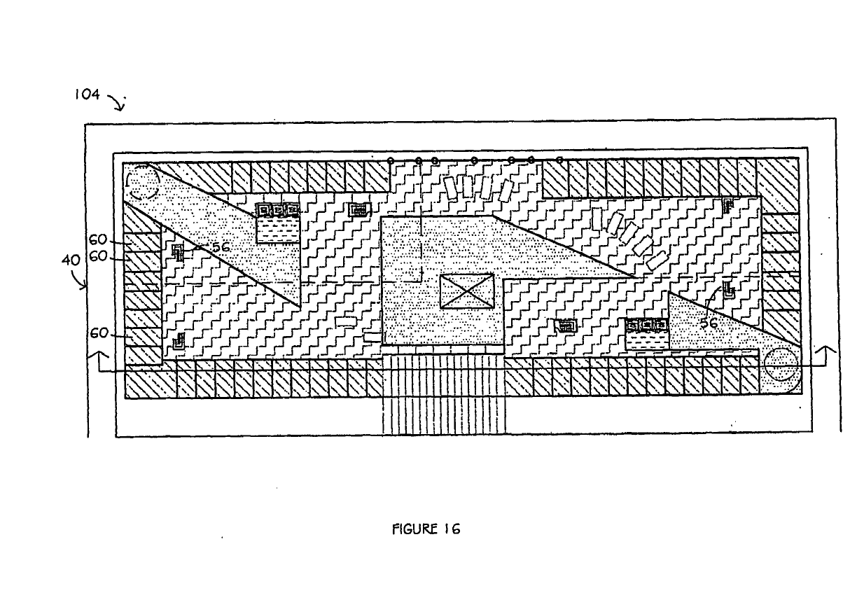

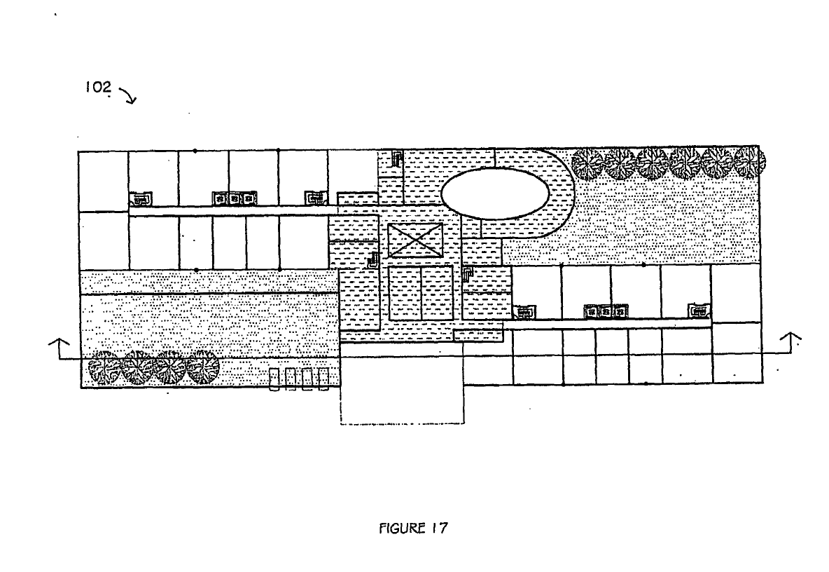

A second preferred embodiment of the building, with which the method can be used, is shown in FIGS. 12-17 and designated with general reference 20A. This building 20A is similar in structure and function to the building 20 of FIGS. 1-11, with equivalent components thereof being similarly identified. Accordingly, a detailed description of this building 20A is not necessary, nor provided hereinafter.

Turning now to the preferred method, same comprises the step of providing, for compensation, occupancy rights in the nature of a lease to said automotive dealership space 24 to a business, specifically, an automotive dealership associated with a brand; obtaining at least partially-exclusive rights to use the brand in association with said multi-unit structure 26; and providing, for compensation, occupancy rights to the units 62 in said multi-unit structure. In the context of the building 20 illustrated in FIGS. 1-7, a preferable arrangement is a dealership representing three automotive brands, with each tower 34 and incorporated showroom 42 being dedicated to a respective one of the marks. The residential dwelling units 62 in each tower 34 are preferably arranged in the nature of a condominium, with the décor of the lobby areas 64,66 of such tower 34 being continued throughout the common elements of such tower 34. Certain of the dwelling units 62 have exclusive use of one or more of the glass carports 86. Others have vehicle-receiving pads 70. Yet other units have exclusive use of one or more of the parking spaces, or joint access to the spaces provided on the basement levels 110,112. The method results in a synergistic arrangement between automotive manufacturers, automotive dealers and automotive aficionados.

Automotive manufacturers obtain a novel income stream from a source heretofore unknown, namely, real estate royalties and mortgages. Further, they obtain automotive dealers which are in particularly advantageous marketing positions, which is expected to increase vehicle sales and owner satisfaction.

Automotive dealers obtain intimate proximity to a pool of customers. The proximity permits relatively high levels of customer service to be achieved, with relatively low levels of effort as compared to existing business models. Dealers, for example, can arrange vehicle service for a resident during time periods when the vehicle of the resident is not in use, for example, in the evenings, with no inconvenience to the resident in terms of travel to and from the dealership. Dealers also benefit from the parking area shared with the residential tenancy. During working hours, when parking needs of residents and their guests are relatively low, the dealer may use a portion of the parking space associated therewith for its clientele. This reduces the footprint of the dealership, and reduces costs.

Automotive afficianados obtain the ability to purchase housing stock associated with their automobiles, which has heretofore been relatively difficult or impossible to obtain. By making the branding rights at least partially exclusive, the housing stock then becomes a limited edition item, at least within a particular geographic area served by the dealership, thereby further increasing the perception of exclusivity. Further, they obtain intimate proximity to a dealership, which enhances their ability to ensure that their vehicles are maintained in excellent condition.

In a preferred version of the method, each unit owner will be provided with a vehicle of the brand, preferably updated yearly to the current model year, and paid for out of the maintenance fees attributable to the unit. In this way, the unit owner can leverage the unit value further, since the appraised value of the unit will be increased due to the amenities and services provided. The developer/operator of the property will pay the brand proprietor a set fee per unit sold, which fee the brand proprietor will use towards the initial cost of the vehicle. The remaining monthly vehicle financing will be paid through the maintenance fees attributable to the unit, which will be slightly increased to pay the monthly vehicle cost. For example, the developer might pay the brand proprietor $50,000 at unit closing. This money, in turn, would be put into an investment selected by the brand proprietor, and the income generated by the investment, along with a portion of the monthly maintenance fee, will be used to pay for the vehicle associated with the unit. As the vehicle is contemplated to be turned-over yearly, it would be obtained for the unit on the basis of a one year lease. The bundling of two highly required and demanded products, namely, automobiles and housing, into one package for one cost, enables financing costs to be reduced and the brand loyalty of the unit owner to be strengthened.

Yet a further feature relates to a multifunction touch screen strategically located in each residential unit. This screen is connected to a network which allows the unit owner to control security systems and home automation systems, view their own personal underground parking spots, book concierge services, book service with the resident automotive dealer and view the service garage of the resident brand dealer. As an added benefit, the brand proprietor is provided access to the network, to permit the brand proprietor to market new products and events to the unit occupants.

Without intending to be limited, it is perceived that buildings constructed according to the first preferred embodiment would be advantageously used in conjunction with exotic automotive marques, such as Lamborghini®, Bentley®, Ducati®. It is common for a single automotive dealer to carry more than one brand of vehicles of this type, in part due to the relatively low levels of sales typically associated with such exotic vehicles. The building of the first preferred embodiment would permit such a dealer to devote one showroom to each marque. Again, without intending to be limited, it is perceived that buildings constructed according to the second preferred embodiment would be advantageously used in conjunction with luxury vehicles, such as Mercedes® or Audi®, which are relatively more commonplace and attract a larger clientele.

Whereas only two preferred embodiments of the building are illustrated, it should be understood that various modifications can be made. For example, whereas multiple occupancy residential structures are described, the multi-unit structures could include commercial occupancy units.

Further, whereas only a single method is described, it will be understood that various modifications thereto can also be carried out. For example, it is contemplated that a number of the buildings could be constructed in different cities and organized in a network. Each building would be linked to the other buildings for high-speed data transmission, such that the occupants of the buildings could have free local calling privileges in all calling areas in which buildings of the network are located. The building occupants could also share services. For example, each unit-owner could be provided time-shares in a commonly-owned plane. Each unit owner could also be provided time-shares for accommodations, so that, when the unit owner is traveling to a city in which another building of the network is located, he or she can stay in a guest suite in said other building.

Yet further, whereas the vehicle transport means of the preferred embodiment transports vehicles, only, it is contemplated that the lift could be modified to carry passengers in addition to vehicles. For example, the cradle could be mounted to a lower portion of the lift, and an upper portion of the lift could include a cabin or deck for passenger transport.

Accordingly, it should be understood that the scope of the invention is to be limited only by the claims appended hereto, purposively construed.

1. A building comprising:
a commercial showroom; and
a multiple-occupancy structure directly accessible from the commercial showroom.

2. A building according to claim 1, wherein the multi-occupancy structure is residential.

3. A building according to claim 1, wherein the commercial showroom is an automotive showroom.

4. A building according to claim 3, wherein the automotive showroom forms part of an automotive dealership.

5. A building according to claim 4, further comprising automotive parking space.

6. A building according to claim 5, wherein the automotive dealership further comprises service space.

7. A building according to claim 6, wherein the commercial showroom is on a ground floor of the building and the service space and automotive parking space are each disposed at least in part beneath the ground floor.

8. A building according to claim 1, wherein the building further comprises private lobby space which is selectively accessible from the showroom, and which provides for said direct access to the multiple occupancy structure from the showroom.

9. A building according to claim 9, wherein the building further includes public lobby space contiguous with the showroom and wherein the private lobby space is selectively accessible from the showroom via the public lobby space.

10. An improved multi-story building of the type having an adjacent road and residential dwelling units disposed on more than one of said stories, wherein the improvement comprises:
a plurality of vehicle-receiving pads disposed in vertically-spaced relation to one another, each pad being associated with a respective one or the dwelling units and contiguous therewith.

11. An improved building according to claim 10, wherein each of the vehicle-receiving pads has a stand for supporting a vehicle in elevated relation to said each pad.

12. An improved building according to claim 11, wherein the building has a staging area and also has a track area along which the vehicle can be driven between the staging area and said adjacent road.

13. Apparatus for use with the building of claim 12 and with a vehicle, said apparatus comprising:
vehicle transport means for moving said vehicle between the staging area of said building and the stand of each vehicle-receiving pad of said building.

14. A business method for use with a building comprising a commercial showroom and a multiple-occupancy structure directly accessible from the showroom, said method comprising the steps:
providing, for compensation, tenancy rights to said showroom to a business associated with a brand;
obtaining rights to use the brand in association with said structure;
providing, for compensation, occupancy rights to the units in said structure.

15. A method according to claim 14, wherein the brand is an automotive marque.

16. A method according to claim 15, wherein the business associated with the brand is an automotive dealership.

17. A method according to claim 14, wherein the tenancy rights provided to the business associated with the brand are in the nature of a lease.

18. A method according to claim 14, wherein the structure is a residential condominium.

19. A method according to claim 14, wherein the rights associated with the brand are at least partially exclusive.
